(19) United States
(12) Patent Application Publication
(10) Pub. No.: US 2018/0200898 A1
(43) Pub. Date: Jul. 19, 2018

(54) CUTTING IMPLEMENT FOR HAMMER TACKER

(71) Applicant: STACPOL GENERAL CONSTRUCTION LTD., Calgary (CA)

(72) Inventor: EDMUND KIERECKI, Calgary (CA)

(21) Appl. No.: 15/873,618

(22) Filed: Jan. 17, 2018

Related U.S. Application Data
(60) Provisional application No. 62/447,808, filed on Jan. 18, 2017.

(51) Int. Cl. B26B 11/00; B25C 5/11; B26B 5/00

(52) U.S. Cl. CPC B26B 11/00; B26B 5/003; B26B 5/002; B25C 5/11

(57) ABSTRACT

A cutting implement for use with a hammer tacker is provided comprising an elongated plate for attaching to an elongated top surface of the hammer tacker; a pair of side walls extending upwardly from each side of the elongated plate and forming a slot for receiving a cutting blade; and an actuator for moving the cutting blade from a retracted position to an extended position through the slot such that when the cutting blade is in the extended position, a portion of the cutting blade extends past a front end of the hammer tacker without significantly obscuring a side to side sight line of the hammer tacker; whereby the elongated plate is sized and shaped such that when the elongated plate is attached to the elongated top surface it does not substantially increase the side to side dimensions of the hammer tacker.

### FIELD OF INVENTION

This invention relates generally to a hammer tacker, and, more specifically, to a cutting implement adapted to be used with a conventional hammer tacker.

### BACKGROUND OF THE INVENTION

A conventional hammer tacker is used for driving staples into a work piece. Generally, a hammer tacker comprises a body and a staple magazine attached to the body for holding the staples. Hammer tackers may also include a handle for gripping same such that a “hammering” action dispenses the staples, as opposed to squeezing a lever, as is the case for lever-operated staplers. Hammer tackers are commonly used to tack down construction materials such as insulating materials, sheet materials, roofing paper and the like. An example of a typical hammer tacker is shown in U.S. Pat. No. 7,537,147.

Often the construction materials, in particular, when being attached to corners and the like, require cutting to fit in the particular space. Conventional utility knives are usually used for cutting the material. However, use of such conventional knives require the tacker operator to put down the tacker and pick up the knife for cutting. Hammer tackers having a cutter positioned on the opposite end from where the staples are dispensed are known in it art (see, for example, U.S. Pat. No. 5,911,761 and U.S. Publication No. 2006/0253996). However, the disadvantage of these hammer tackers is that the hammer tacker must be rotated in order to access the cutting portion, which may result in dropping the tacker.

U.S. Pat. No. 6,823,592 discloses a hammer tacker having a cutter attached to the top of a conventional hammer tacker. However, the blade is positioned on a side extension and therefore projects at an angle relative to the tacker body. Because of such side extension, it may cover the field of visibility during operation and may prevent the operator from operating the hammer tacker in an inside corner, around windows and doors, etc.

### SUMMARY OF INVENTION

The present invention provides a cutting implement for use with a conventional hammer tacker and a hammer tacker having such a cutting implement.

In one aspect, a cutting implement is provided for attaching to a hammer tacker, comprising:
an elongated plate for attaching to an elongated top surface of the hammer tacker;
a pair of side walls extending upwardly from each side of the elongated plate, said side walls forming a slot for receiving a cutting blade; and
an actuator for moving the cutting blade from a retracted position to an extended position through the slot such that when the cutting blade is in the extended position, a portion of the cutting blade extends past a front end of the hammer tacker without significantly obscuring a side to side sight line of the hammer tacker;
   whereby the elongated plate is sized and shaped such that when the elongated plate is attached to the elongated top surface it does not substantially increase the side to side dimensions of the hammer tacker.

In one embodiment, the elongated plate is attached to the elongated top surface by means of a fastener. Examples of fasteners useful for attaching the elongated plate to the elongated top surface of the hammer tacker are screws, bolts, nails, nuts, pins, clips, rivets, rods, and other such anchors. In another embodiment, the elongated plate is attached to the elongated top surface of the hammer tacker by means of glue such as epoxy glue, cyanoacrylate adhesives, and the like. In another embodiment, the elongated plate is attached to the elongated top surface of the hammer tacker by welding, brazing, soldering, and the like.

In one embodiment, the side walls have inwardly overturned side edges to hold the cutting blade securely.

In another aspect, a hammer tacker and cutting apparatus is provided, comprising:
a hammer tacker having a substantially level elongated top surface;
an elongated plate for attaching to the elongated top surface of the hammer tacker;
a pair of side walls extending upwardly from each side of the elongated plate, said side walls forming a slot for receiving a cutting blade; and
an actuator for moving the cutting blade from a retracted position to an extended position through the slot such that when the cutting blade is in the extended position, a portion of the cutting blade extends past a front end of the hammer tacker without significantly obscuring a side to side sight line of the hammer tacker;
   whereby the elongated plate is sized and shaped such that when the elongated plate is attached to the elongated top surface it does not substantially increase the side to side dimensions of the hammer tacker.

### BRIEF DESCRIPTION OF THE DRAWINGS

Drawings are included for the purpose of illustrating certain aspects of the invention. Such drawings and the description thereof are intended to facilitate understanding and should not be considered limiting of the invention. Drawings are included, in which:

FIG. 1 is a perspective view of an elongated plate of a cutting implement of the present invention.

FIG. 2 is a perspective view and partial cut-away of the elongated plate shown in FIG. 1.

FIG. 3 is a perspective view of an embodiment of an actuator useful in a cutting implement of the present invention.

FIG. 4 is a perspective view of a blade useful in a cutting implement of the present invention.

FIG. 5 is a perspective view of a hammer tacker having a cutting implement of the present invention attached thereto.

FIGS. 6A and 6B are top views of the hammer tacker as shown in FIG. 5 when the cutting blade is extended and retracted, respectively.

FIGS. 7A (Prior Art), 7B (Prior Art) and FIG. 7C (Prior Art) are top view, cross section and perspective view, respectively, of a hammer tacker useful in the present invention.

FIGS. 8A, 8B and 8C are top view, cross section and perspective view, respectively, of a hammer tacker having a cutting implement of the present invention attached thereto.

### DETAILED DESCRIPTION OF VARIOUS EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

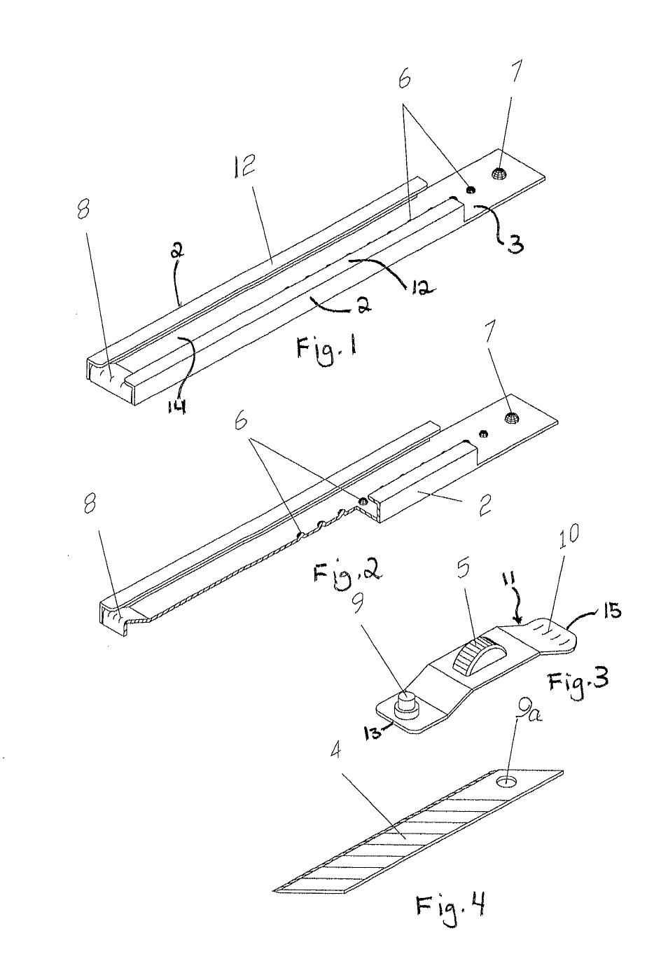

The various components of one embodiment of a cutting implement of the present invention are shown in FIGS. 1-4. In this embodiment, the cutting implement comprises an elongated plate (3) having two side plates (2), each side plate having overturned edges (12) forming a slot (14) for receiving a cutting blade (4), and actuator (11) shown in FIG. 4 and FIG. 3, respectively. At one end of elongated plate (3) is a raised hemi-spherical knob (7) and at the opposite end of the elongated plate (3), the plate is bent first upwardly and then downwardly to form a lip (8). FIG. 2 is a partial cut-away of FIG. 1, which shows the contour of lip (8). The lip (8) aids in stabilizing blade (4), as will be described in more detail below. Elongate plate (3) further comprises a plurality of additional, raised smaller knobs (6), which profiles can be seen in FIG. 2.

Actuator (11), as shown in FIG. 3, is useful for both securing cutting blade (4) and for moving cutting blade (4) forwards and backwards through slot (14). Actuator (11) comprises a cutting blade fastener (9) at first end (13), which fastener (9) can be inserted in aperture (9a) of cutting blade (4) to secure the cutting blade (4) to the actuator (11). Actuator (11) further comprises a dial (5) which can move the blade (4) either forwards and backwards, to extend or retract the blade (4). Second end (15) comprises a v-shaped depression (10) which stops the blade (4) from extending too far forward by allowing the depression (10) to rest in between two adjacent smaller knobs (6).

As shown in FIG. 4, blade (4) can be formed of a plurality of segments (4a) such that when the tip of the blade (4) gets dull, the spent segment of blade (4) can be broken off and a new segment of the blade (4) can now be exposed for use.

Actuator (11), and blade (4) attached thereto, is sized to freely slide back and forth in slot (14) formed by plates (2) and the overturned edges (12) serve to retain the actuator (11) and blade (4) while still allowing the actuator and blade to move forwards and backwards to extend or retract blade (4). It is understood that other actuators that can move a cutting blade forwards and backwards could also be used in the present invention. When blade (4) is moved forward past the raised lip (8) of elongated plate (2), the raised lip (8) helps fix the blade in position so that the blade is secure enough to cut the building material.

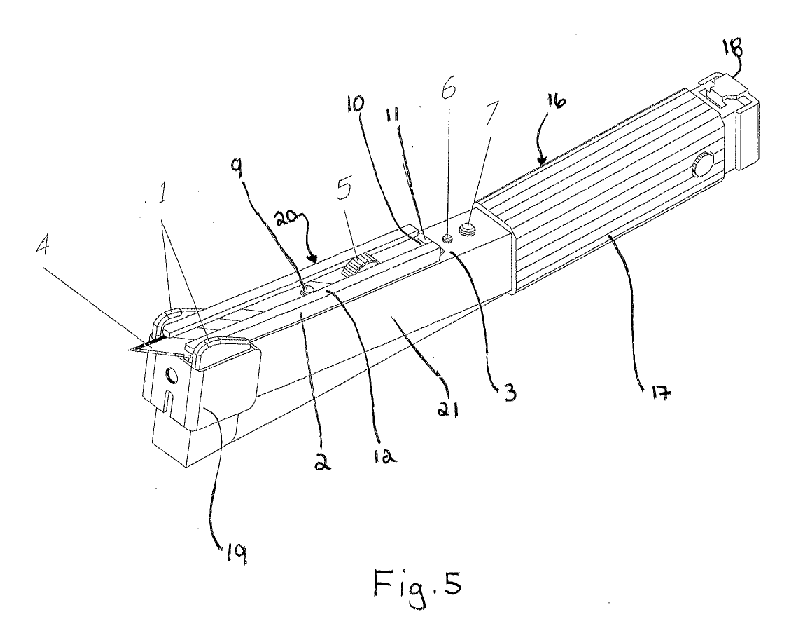

FIG. 5 is a perspective view of the assembled cutting implement (20) of the present invention attached to a conventional hammer tacker. An example of a hammer tacker useful in the present invention is described in U.S. Pat. No. 7,537,147, incorporated hereto by reference. In FIG. 5, hammer tacker (16) comprises a hand grip (17) at one end, which grip can be made of a non-slip material such as rubber, or can be made of steel, etc. and wrapped with rubber, etc., to provide a stronger grip. At the end of the hand grip (17) is a staple magazine (18), which can be inserted into the hand grip by means known in the art. At the other end of hammer tacker (16) is an elongated top surface (22) at or near the stapling portion (21) comprising stapling head (19), which operation is known in the art.

Cutting implement (20) is fixed to the elongated top surface (22) of the hammer tacker (16) by any means known in the art, such as gluing, welding, screwing, etc. To allow the cutting implement (20) to be fixed to the elongated top surface (22), as well as to improve the aesthetics of the tool, certain structural changes may need to be made to an existing hammer tacker tool.

In one embodiment of a hammer tacker useful in the present invention, which is shown in FIGS. 7A, 7B and 7C (Prior Art), the hammer tacker (216) comprises an overturned lip (224) at the front of the stapling portion (219). Screw (231a) secures lip (224) to the elongated tope surface (222) of the tacker hammer (216). As well, screw 231a, together with screw 231b, secures weight (226), which weight can be made of a heavy metal such as steel, for exerting more force on the stapling portion (221) of the tacker hammer (216) for embedding the staples in a material. Thus, screws (231a, 231b) must be removed to provide a substantially level elongated top surface (222). Once the lip (224) and screws (231a, 231b) are removed, the elongated top surface (222) will be flat and will allow for the installation of the cutting implement (220), as shown in FIG. 7C.

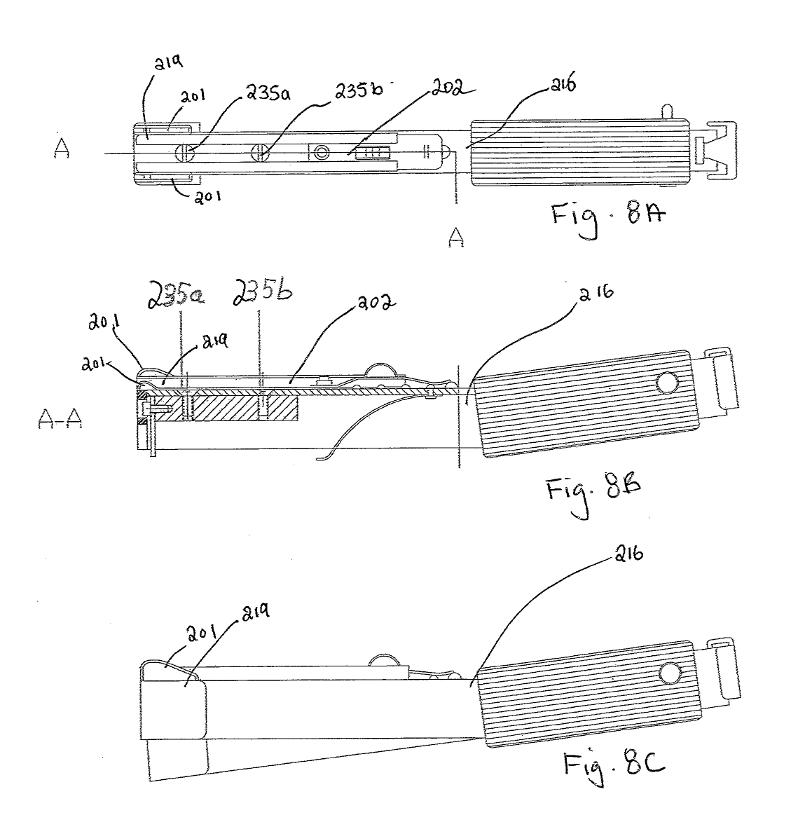

As shown in FIGS. 8A, 8B and 8C, two countersunk screws (235a, 235b) can now be used to both fixing the weight (226) and the cutting implement (220) in place. First, the weight can be fixed into place with countersunk screws, the head of which goes completely into the plane of the elongated top surface (222) and leaves a flat surface.

In another embodiment, instead of using any screws, two holes can be drilled into the sides of the stapling portion of a tacker hammer the weight can be welded to the body of the stapling portion through these holes. In another embodiment, spot-welding can be used in two spots on each of the sides of the body of the stapling portion, or on the top, or in other places. The spot-welding requires a very exact fit of the weight with the inner structure of the body of the stapling portion.

In one embodiment, hammer tacker (16) may further comprise a pair of small, upright wing members (1) attached to the top of the stapling head (19) which provide protection to the blade (4) in case the user hits anything with the top of the stapling head; this may occur by accident or may be done intentionally. If the upright wing members (1) were not present and the user inadvertently struck any object, such as a wall, with the top of the stapling head (19) a segment of the blade (4) may break off or, what would be worse, the overturned edges (12) may get bent, warped or damaged and have a severe impairment on the functionality of the cutting implement (20).

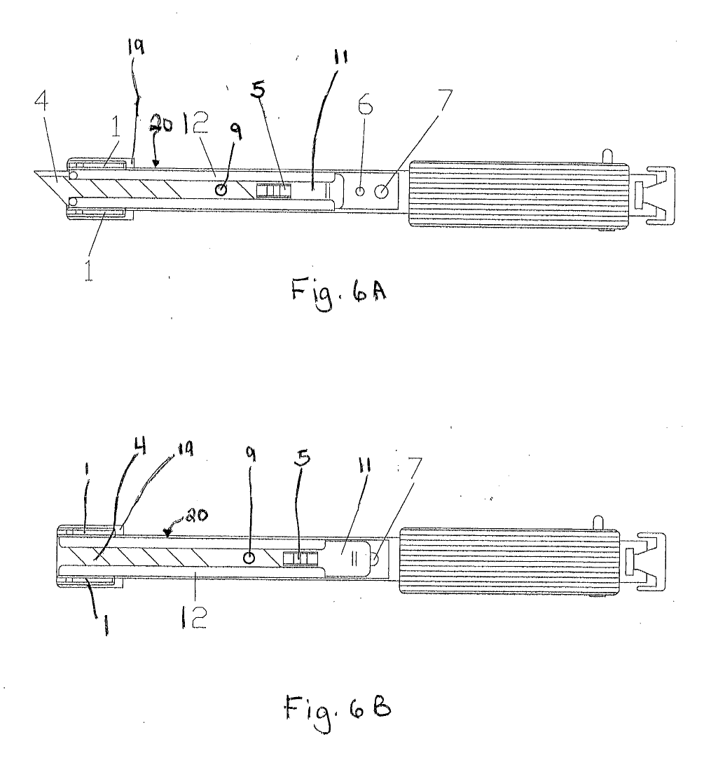

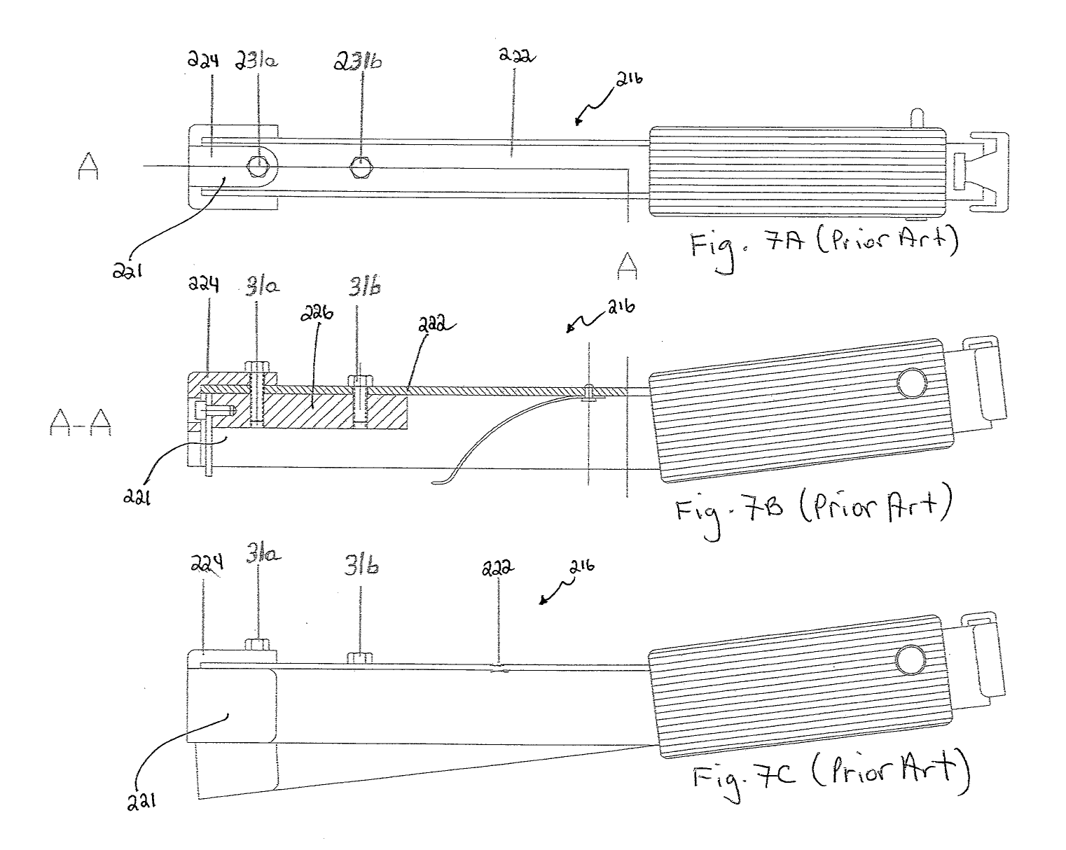

As can be seen more clearly in the top views in FIGS. 6A and 6B, when cutting implement (20) is attached to the hammer tacker (16), and, in particular, when the cutting blade is in the retracted position as shown in FIG. 6B, the cutting implement (20) does not substantially cover the field of visibility of the user of the hammer tacker and it still allows the operator to use the hammer tacker in an inside corner, around windows and doors, etc. However, when cutting of materials is necessary, the user can easily extend the cutting blade (4) forward to engage in the cutting operation. Further, because the cutting blade (4) only extends from the front of the hammer tacker (FIG. 6A), it is much safer for the user and there is less chance of the user injuring himself during cutting operations. Further, because the cutting blade (4) can be flipped in either direction when loading into the cutting implement, both a left-handed and a right-handed user can use it with equal comfort and skill. Additionally, because the cutting blade is positioned on its side, with the sharp cutting edge on either the left side (for right-handed users) or the right side (for left-handed users) should the user accidentally hit him or herself with the cutting blade then the cutting blade will not injure the user.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims. For US patent properties, it is noted that no claim element is to be construed under the provisions of 35 USC 112, sixth paragraph, unless the element is expressly recited using the phrase “means for” or “step for”.

What is claimed:

1. A cutting implement for use with a hammer tacker, comprising:
(a) an elongated plate for attaching to an elongated top surface of the hammer tacker;
(b) a pair of side walls extending upwardly from each side of the elongated plate, said side walls forming a slot for receiving a cutting blade; and
(c) an actuator for moving the cutting blade from a retracted position to an extended position through the slot such that when the cutting blade is in the extended position, a portion of the cutting blade extends past a front end of the hammer tacker without significantly obscuring a side to side sight line of the hammer tacker;
whereby the elongated plate is sized and shaped such that when the elongated plate is attached to the elongated top surface it does not substantially increase the side to side dimensions of the hammer tacker.

2. The cutting implement of claim 1, wherein each side wall comprises overturned edges to retain the cutting blade in the slot.

3. The cutting implement of claim 1, wherein the elongated plate comprises a raised lip at its front end to fix the cutting blade when it is in the extended position.

4. The cutting implement of claim 1, wherein both the cutting blade and the actuator can be moved through the slot.

5. The cutting implement of claim 1, wherein the actuator comprises a cutting blade fastener to secure the cutting blade to the actuator.

7. The cutting implement of claim 6, wherein the actuator further comprises a dial for moving the cutting blade from the retracted position to the extended position.

8. A hammer tacker and cutting apparatus, comprising:
(a) a hammer tacker;
(b) an elongated plate for attaching to an elongated top surface of the hammer tacker;
(c) a pair of side walls extending upwardly from each side of the elongated plate, said side walls forming a slot for receiving a cutting blade; and
(d) an actuator for moving the cutting blade from a retracted position to an extended position through the slot such that when the cutting blade is in the extended position, a portion of the cutting blade extends past a front end of the hammer tacker without significantly obscuring a side to side sight line of the hammer tacker;
whereby the elongated plate is sized and shaped such that when the elongated plate is attached to the elongated top surface it does not substantially increase the side to side dimensions of the hammer tacker.

9. The hammer tacker and cutting apparatus of claim 8, wherein the elongated plate is attached to the elongated top surface by means of a fastener.

10. The hammer tacker and cutting apparatus of claim 9, wherein the fastener is selected from the group consisting of screws, bolts, nails, nuts, pins, clips, rivets, and rods.

11. The hammer tacker and cutting apparatus of claim 8, wherein the elongated plate is attached to the elongated top surface of the hammer tacker by means of glue.

12. The hammer tacker and cutting apparatus of claim 11, wherein the glue is an epoxy glue or a cyanoacrylate adhesive.

13. The hammer tacker and cutting apparatus of claim 8, wherein the elongated plate is attached to the elongated top surface of the hammer tacker by welding, brazing, or soldering.

14. The hammer tacker and cutting apparatus of claim 8, wherein the hammer tacker further comprises a hand grip.

15. The hammer tacker and cutting apparatus of claim 8, wherein each side wall comprises overturned edges to retain the cutting blade in the slot.

16. The hammer tacker and cutting apparatus of claim 8, wherein the elongated plate comprises a raised lip at its front end to fix the cutting blade when it is in the extended position.

17. The hammer tacker and cutting apparatus of claim 8, wherein both the cutting blade and the actuator can be moved through the slot.

18. The hammer tacker and cutting apparatus of claim 8, wherein the actuator comprises a cutting blade fastener to secure the cutting blade to the actuator.

19. The hammer tacker and cutting apparatus of claim 18, wherein the actuator further comprises a dial for moving the cutting blade from the retracted position to the extended position.
